(19) United States
(12) Patent Application Publication
(10) Pub. No.: US 2009/0029084 A1
(43) Pub. Date: Jan. 29, 2009

(54) MULTILAYER FORMS AND METHODS OF PRODUCING THE SAME

(76) Inventor: Ronald R. Garrison, Batavia, IL (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/938,024

(22) Filed: Nov. 9, 2007

Related U.S. Application Data
(60) Provisional application No. 60/952,469, filed on Jul. 27, 2007.

(51) Int. Cl. B32B 33/00; B32B 37/12; B65D 65/28

(52) U.S. Cl. 428/41.8; 156/60; 428/43

(57) ABSTRACT

Multilayer forms and methods for producing the same are described. An example multilayer form includes a first layer with a first front face and a first back face, a second layer with a second front face and a second back face, and a third layer with a third front face and a third back face. The example multilayer form also includes a first line of weakness through at least the second layer and the third layer, and the three layers are coupled together between a first end and the first line of weakness. In addition, a second line of weakness extends through at least the first layer and the third layer, and at least the first layer and third layer are coupled between the second line of weakness and a second end.

### RELATED APPLICATION

This application claims priority to U.S. Provisional Application Ser. No. 60/952,469, which was filed on Jul. 27, 2007 and is hereby incorporated herein by reference in its entirety.

### FIELD OF DISCLOSURE

The present disclosure relates generally to forms and, more particularly, to multilayer forms and methods of producing the same.

### BACKGROUND

Typically, multilayer forms include a base layer and one or more upper layers attached thereto. Multilayer forms have a variety of applications including, for example, booklets of labels. Typically, the layers of a conventional multilayer form are coupled at only a single edge and remain detached at the other edges. The layers can move freely at the second edge and, thus, may separate or move apart from each other (e.g., flap or flutter), particularly when these multilayer forms are moved. Because the layers of conventional multilayer forms may separate or move apart, these forms can easily jam machinery or processing equipment and may not be readily inserted into envelopes. Furthermore, these multilayer forms may not be used as mailers because they may not meet all United States Postal Service (USPS) guidelines and may become lodged in the processing equipment.

In addition, conventional multilayer forms may suffer from curling, where the base layer and the upper layers begin to roll upward and do not lay flat. Curled multilayer forms may not be automatically processed by the USPS or in other machinery without increasing the likelihood of jamming the machines, being improperly inserted into envelopes, or otherwise causing malfunctions.

### BRIEF DESCRIPTION OF THE DRAWINGS

FIG. 1A is a schematic view of an example multilayer form.

FIG. 1B is a schematic view of the example multilayer form of FIG. 1A showing the multiple layers.

FIG. 2 is an exploded view of the example multilayer form of FIGS. 1A and 1B.

FIG. 3 is a cross-sectional view of the example multilayer form of FIG. 1A through the A-A line.

FIG. 4 is a schematic view of an alternative example multilayer form.

FIG. 5 is a flow chart depicting an example process to produce an example multilayer form.

### DETAILED DESCRIPTION

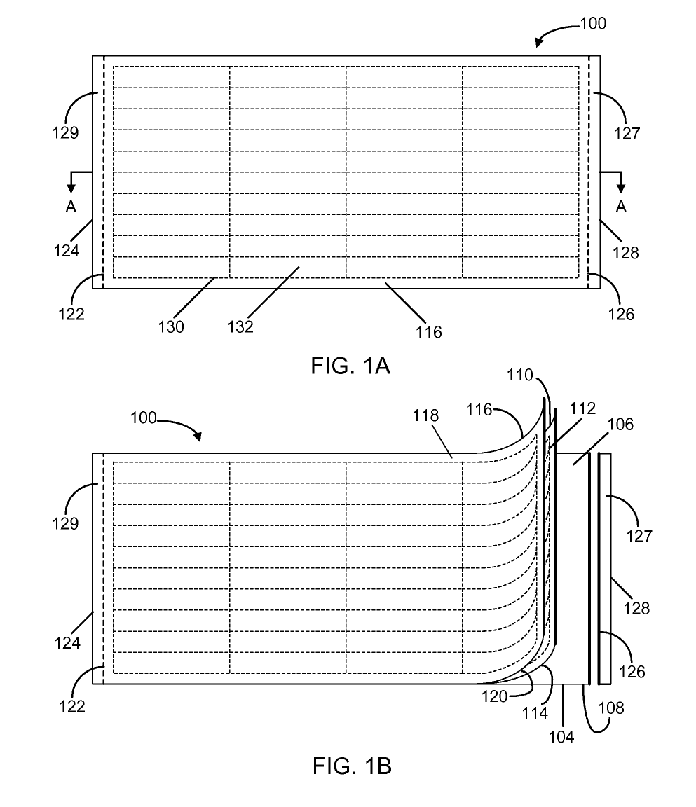

The article of manufacture shown in FIGS. 1-3 is an example multilayer form 100. The multilayer form 100 includes a plurality of layers and may form, for example, a booklet that may be inserted into an envelope or, as described in greater detail below, a mailer. The multilayer form 100 includes a base sheet or first layer 104, with a first front face 106 and a first back face 108, an intermediate sheet or second layer 110, with a second front face 112 and a second back face 114, and a top sheet, or third layer 116, with a third front face 118 and a third back face 120. In the illustrated example, the first layer 104 has a thickness greater than the second layer 110 and the third layer 116 and, as a result, the multilayer form 100 does not easily curl, lays flat, and may be easily processed in a machine and/or inserted into an envelope. Though only three layers are shown in the illustrated example, there may be any number of layers.

The first layer 104, the second layer 110 and the third layer 116 are coupled as described in greater detail below. Together, the first layer 104, the second layer 110 and the third layer 116 form the example multilayer form 100. Each of the layers 104, 110 and 116 of the multilayer form 100 has a first end 124 and a second end 128. In addition, the multilayer form 100 includes a first line of weakness 122 and a second line of weakness 126 on and/or through at least one or more of the layers 104, 110 and 116 as described in greater detail herein. The lines of weakness 122 and 126 may include, for example, any combination of creases, folds, die-cuts, kiss-cuts, perforations, etc.

In the illustrated example, the three layers 104, 110 and 116 are coupled together between the first line of weakness 122 and the first end 124. Further, the first line of weakness 122 may extend through at least the second layer 110 and the third layer 116. At least the first layer 104 and third layer 116 are coupled together between the second line of weakness 126 and the second end 128. The second line of weakness 126 may extend through at least the first layer 104 and the third layer 116. The portion of the third layer 116 and the first layer 104 between the second line of weakness 126 and the second end 128 form a removable tab 127. The portions of the first, second and third layers 104, 110 and 116 between the first line of weakness 122 and the first end 124 form a spine 129.

As shown in FIG. 1B, when the removable tab 127 is removed, the first layer 104 and the second layer 110 may be accessed. Furthermore, the second layer 110 and the third layer 116 may be removed from the multilayer form 100 by tearing the second layer 110 and/or the third layer 116 along the first line of weakness 122.

FIGS. 1A and 1B also illustrate that the example multilayer form 100 may include secondary lines of weakness 130. In the example, the secondary lines of weakness 130 form a plurality of removable labels 132 on at least the second front face 112 and the third front face 118. The secondary lines of weakness 130 may include, for example, creases, folds, die-cuts, kiss-cuts, perforations, etc. or any combination thereof. The example multilayer form 100 includes a grid of forty rectangular labels 132, which increases the usable area of the second front face 112 and the third front face 118 and decreases the amount of the waste matrix that may otherwise appear in the multilayer form 100. In other examples, the layers 104, 110 and 116 may include any number or type of labels, graphics, data, information, coupons, stickers, etc. on any combination of the front faces 106, 112 and 118 and/or the back faces 108, 114 and 120.

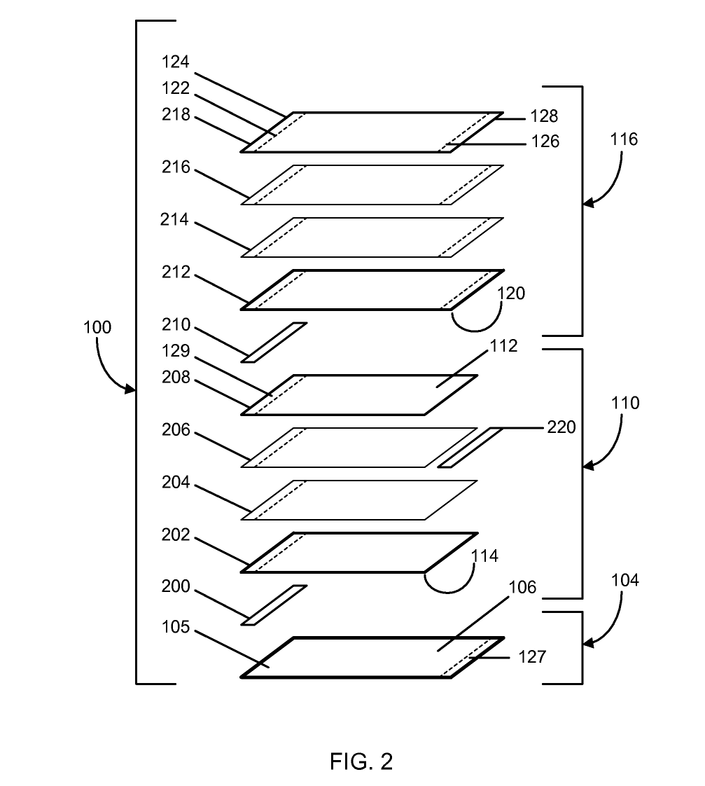

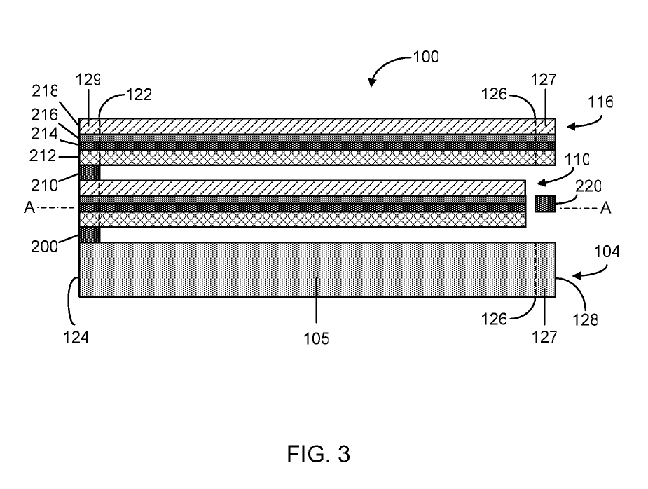

FIG. 2 illustrates an exploded view of the example multilayer form 100 of FIG. 1 and FIG. 3 is a cross-sectional view taken along the A-A line of FIG. 1A. The example multilayer form 100 is not drawn to scale but dimensioned for clarity. In the illustrated example, the first layer 104 includes a first substrate 105, and the second layer 110 and the third layer 116 include a plurality of layers. In an alternative example, the first layer 104 also may include a plurality of layers. As shown, the second layer 110 includes a second substrate 202, a first label release liner 204, a first label adhesive layer 206 and a first label layer 208. The third layer 116 includes a third substrate 212, a second label release liner 214, a second label adhesive layer 216 and a second label layer 218. In the illustrated example, the first label adhesive layer 206 and the second label adhesive layer 216 may be an entire layer, a substantially entire layer, a series of dots, strips, any other pattern, or a combination thereof. In addition, the first label adhesive layer 206 and the second label adhesive layer 216 may be any suitable adhesive or combination of adhesives including, for example, a pressure sensitive adhesive. The first label release liner 204 and the second label release liner 214 facilitate the removal of label(s) from the second layer 110 and third layer 116, respectively. In the example multilayer form 100, the first label release liner 204 and the second label release liner 214 may be any suitable release coating or combination of release coatings including, for example, a silicone-based release coating. Further, the first label layer 208 and the second label layer 218 may include any number of labels, any shapes of labels, and any other type of labels including any text, images, other information, or any combination thereof.

As shown in FIGS. 2 and 3, the first line of weakness 122 extends through the second layer 110 and the third layer 116, while the second line of weakness 126 extends through the first layer 104 and the third layer 116. The second line of weakness 126 does not extend through the second layer 110 in this example because the second layer 110 is shorter than the first layer 104 and the third layer 116. In other examples, the second layer 110 may be similar in length to the first layer 104 and/or the third layer 116 and, in that case, the second line of weakness 126 may extend through the second layer 110 as well.

The first layer 104 and the second layer 110 are coupled at the first end 124 via a first sheet adhesive layer 200 that may be applied to at least a portion of the first front face 106 of the first layer 104 and/or to at least a portion of the second back face 114 of the second layer 110 such as, for example, between the first end 124 and the first line of weakness 122. Further, a second sheet adhesive layer 210 is applied to at least a portion of the second front face 112 of the second layer 110 and/or to at least a portion of the third back face 120 of the third layer 116 such as, for example, between the first end 124 and the first line of weakness 122 to couple the second layer 110 and the third layer 116. The example multilayer form 100 also includes a third sheet adhesive layer 220 that may be applied to at least a portion of the first front face 106 of the first layer 104 and at least a portion of the third back face 120 of the third layer 116 for example between the second line of weakness 126 and the second end 128 to couple the first layer 104 and the third layer 116 at the second end 128. Furthermore, the first, second and third sheet adhesive layers 200, 210 and 220 may be any suitable adhesive(s) including, for example, a pressure sensitive adhesive.

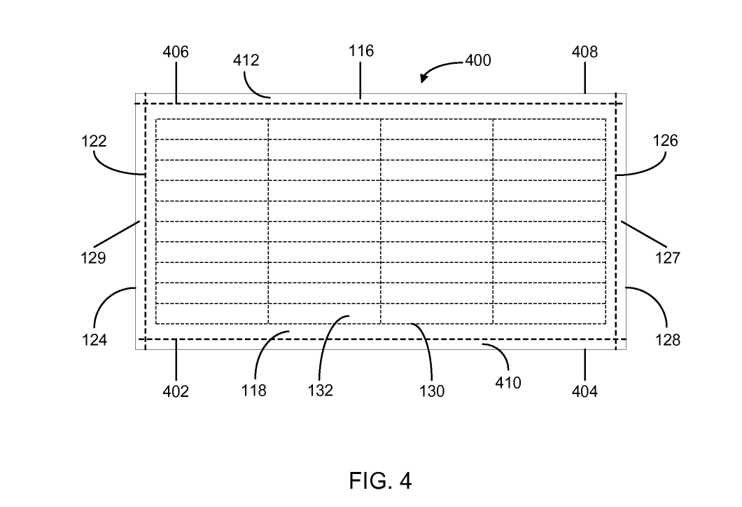

FIG. 4 illustrates an alternative example multilayer form 400. The example multilayer form 400 of FIG. 4 may be used as a mailer such as, for example, a self-mailer or a continuous mailer, which are forms that may be sent through the mail without the use of a traditional envelope. Many portions of the construction of the example multilayer form 400 are substantially similar to that of the example multilayer form 100 of FIG. 1 and discussion thereof will not be repeated here. Similar numbers are used to designate similar components or structure. The example multilayer form 400 may include additional lines of weakness such as, for example, a third line of weakness 402 and a fourth line of weakness 406. As shown in FIG. 4, the third layer 116 has a third end 404 and a fourth end 408. The second layer 110 and the first layer 104 may also extend to the third end 404 and the fourth end 408. When all of the layers 104, 110 and 116 extend to the third end 404 and the fourth end 408, the third line of weakness 402 and the fourth line of weakness 406 may extend through all three of the layers 104, 110 and 116. Further, the layers 104, 110 and 116 may be coupled via adhesive patterns similar to the sheet adhesive layers 200, 210 and 220 described above. Also, the portions of the adhered layers 104, 110 and 116 between the third line of weakness 402 and the third edge 404 form a second removable tab 410, and the portions of the adhered layers 104, 110 and 116 between the fourth line of weakness 404 and the fourth edge 408 form a third removable tab 412. In an alternative example, the second layer 110 may not have third and fourth ends that coincide with the third and fourth ends 404 and 408, in which case, the third layer 116 and the first layer 104 may be coupled at the third and fourth ends 404 and 408 in a manner similar to the coupling of the third layer 116 and the first layer 104 at the second end 128.

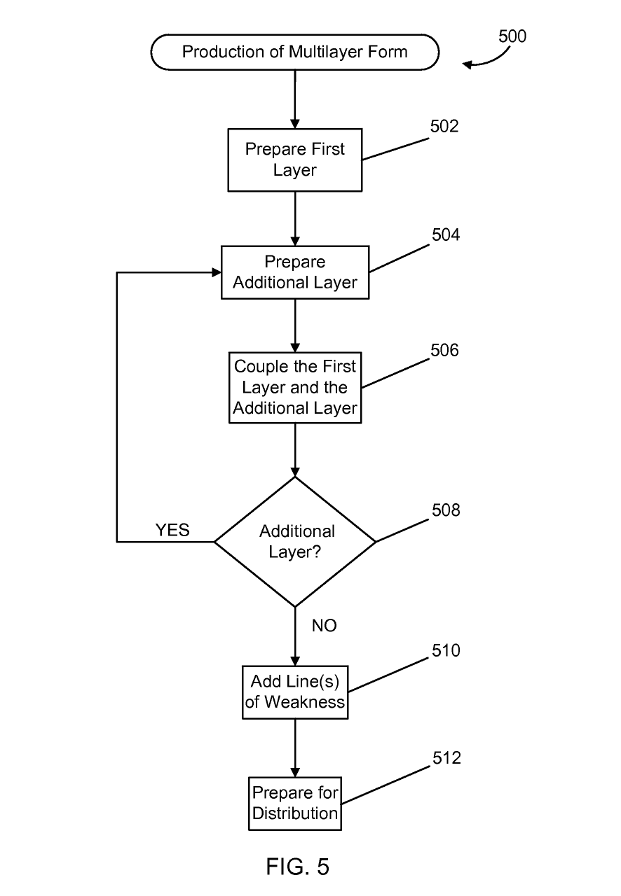

The example multilayer form 400 is closed at all four of the ends 124, 128, 404 and 408. Consequently, postage can be applied to the third front face 118 of the third layer 116 or the first back face 108 of the first layer 104, and the multilayer form 400 can be sent as a mailer without inserting the multilayer form 400 into an envelope (as described above and below with reference to FIG. 5). The recipient of the multilayer form 400 may remove the removable tabs 127, 410 and 412 and access the labels 132 and/or other information that may appear on the third back face 120 of the third layer 116, the second front face 112 and/or the second back face 114 of the second layer 110 and/or the first front face 106 of the first layer 104.

FIG. 5 illustrates an example process 500 for producing an example multilayer form (e.g., the example multilayer form depicted in FIG. 1). In the example process 500, a first layer of the multilayer form (e.g., the first layer 104) is prepared (block 502). Preparation of a layer may include a number of procedures including, for example, printing, trimming, cutting, imaging, treating, applying an adhesive pattern, applying a release coating, coupling the layer with a release liner, and/or kiss cutting, die cutting, or otherwise forming secondary lines of weakness.

An additional layer (e.g., the second layer 110) also is prepared (block 504). Preparation of the additional layer may include one or more of the example procedures described above. The first two layers may be coupled (block 506). The layers may be coupled with any mechanical or chemical fastener including, for example, by applying an adhesive pattern to a portion of a front face of the first layer and/or applying an adhesive pattern to a portion of a back face of the additional layer and applying pressure to or otherwise coupling the layers.

In the example process 500, it is determined if yet another additional layer is to be added (block 508). If another additional layer is to be added, control of the example process 500 returns to block 504 and blocks 504 and 506 may be repeated. When no more additional layers are to be added, one or more lines of weakness may be added to the multilayer form (block 510). As described above, lines of weakness may extend through one or more of the layers and may include, for example, creases, folds, die-cuts, perforations, etc., or any combination thereof. The example multilayer form also is prepared for distribution 512. Preparation for distribution may include, for example, the addition of more lines of weakness, the addition of more adhesive or other fasteners, the addressing of the multilayer form, the inclusion of the multilayer form with or in another product, the insertion of the multilayer form into an envelope, the application of postage or any combination thereof.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. An article of manufacture comprising:
a first layer having a first end, a second end, a front face and a back face;
a second layer having a first end, a second end, a front face and a back face;
a third layer having a first end, a second end, a front face and a back face;
a first line of weakness through at least the second and third layers, wherein the first, second and third layers are coupled between the first line of weakness and the first ends; and
a second line of weakness through at least the first and third layers, wherein the first and third layers are coupled between the second line of weakness and the second ends.

2. An article of manufacture as defined in claim 1, wherein the first and third layers are directly coupled between the second line of weakness and the second ends.

3. An article of manufacture as defined in claim 1, wherein the first and third layers are coupled via the second layer, and wherein the second line of weakness extends through the second layer.

4. An article of manufacture as defined in claim 1, further comprising:
a first layer of adhesive between a portion of the front face of the first layer and a portion of the back face of the second layer and between the first line of weakness and the first ends of the first and second layers; and
a second layer of adhesive between a portion of the front face of the second layer and a portion of the back face of the third layer and between the first line of weakness and the first ends of the second and third layers.

5. An article of manufacture as defined in claim 1 wherein the first and third layers are coupled via an adhesive.

6. An article of manufacture as defined in claim 1, wherein the first layer has a thickness that is greater than at least the second layer.

7. An article of manufacture as defined in claim 1, wherein at least one of the front face or the back face of at least one of the first layer or the second layer includes one or more secondary lines of weakness.

8. An article of manufacture as defined in claim 7, wherein the one or more secondary lines of weakness form removable labels, comprising:
a release liner;
a label layer on which information is presented; and
a releasable adhesive applied to the label layer to secure the label layer to the release liner.

9. An article of manufacture as defined in claim 7, wherein the one or more secondary lines of weakness are formed without producing substantial matrix waste.

10. An article of manufacture as defined in claim 1 further comprising:
a third line of weakness through at least the first layer further having a third end and the third layer further having a third end, wherein the first and third layers are coupled between the third line of weakness and the third ends; and
a fourth line of weakness through at least the first layer further having a fourth end and the third layer further having a fourth end, wherein the first and third layers are coupled between the fourth line of weakness and the fourth ends.

11. An article of manufacture as defined in claim 10, wherein the first and third layers are directly coupled between the third line of weakness and the third ends and the fourth line of weakness and the fourth ends.

12. An article of manufacture as defined in claim 10, wherein the first and third layers are coupled via the second layer, and wherein the third and fourth lines of weakness extend through the second layer.

13. An article of manufacture as defined in claim 1, further comprising an envelope.

14. An article of manufacture as defined claim 1, wherein the article of manufacture is a mailer.

15. A method of producing a booklet comprising:
applying a first adhesive pattern to at least one of a front face of a first layer having a first end, a second end, a front face and a back face or a back face of a second layer having a first end, a second end, a front face and a back face;
coupling the second layer to the first layer, where the first and second layers are coupled between the first line of weakness and the first ends;
applying a second adhesive pattern to at least one of the front face of the second layer or a bottom face of a third layer having a first end, a second end, a front face and a back face;
coupling the third layer to the second layer, where the second and third layers are coupled between the first line of weakness and the first ends;
forming a first line of weakness through at least the second and third layers;
forming a second line of weakness through at least the first and third layers; and
coupling the first and third layers between the second line of weakness and the second ends.

16. A method of producing a booklet as defined claim 15, further comprising:
forming a third line of weakness through at least the first layer further having a third end and the third layer further having a third end;
coupling the first and third layers between the third line of weakness and the third ends;
forming a fourth line of weakness through at least the first layer further having a fourth end and the third layer further having a fourth end; and
coupling the first and third layers between the fourth line of weakness and the fourth ends.

17. A method for producing a booklet as defined in claim 15, further comprising forming secondary lines of weakness on at least one of the front face or back face of at least one of the second layer or third layer.

18. A method for producing a booklet as defined in claim 15 wherein the first layer has a thickness that is greater than at least the second layer.
